(19) United States
(12) Patent Application Publication
(10) Pub. No.: US 2016/0214675 A1
(43) Pub. Date: Jul. 28, 2016

(54) MULTI-MODAL VEHICLES CAPABLE OF LEGALLY TRAVELING IN DIFFERENT CLASSIFICATION CATEGORIES

(71) Applicant: Daniel DECORDOVA, Seattle, WA (US)

(72) Inventor: Daniel DeCordova, Seattle, WA (US)

(21) Appl. No.: 14/917,753

(22) PCT Filed: Sep. 16, 2014
(86) PCT No.: PCT/US2014/055942

§ 371 Date: Mar. 9, 2016

Related U.S. Application Data
(60) Provisional application No. 61/878,503, filed on Sep. 16, 2013.
(60) Provisional application No. 61/882,454, filed on Sep. 25, 2013.

(51) Int. Cl. B62K 13/00; B62M 6/45

(52) U.S. Cl. CPC B62K 13/00; B62M 6/45

(57) ABSTRACT

Vehicles that can function within more than one legal classification category are disclosed. The vehicles can be cycles capable of legally traveling on sidewalks and/or within bike lanes in certain modes and also capable of legally traveling as motor vehicles in different modes. Kits that allow the retro-fitting of existing vehicles into the described multi-modal vehicles are also described.

### CROSS REFERENCES TO RELATED APPLICATIONS

This application is a national phase application based on International Application No. PCT/US2014/055942, filed on Sep. 16, 2014, which claims priority to U.S. Provisional Patent Application Ser. No. 61/878,503, filed Sep. 16, 2013, and U.S. Provisional Patent Application Ser. No. 61/882,454, filed Sep. 25, 2013, the entire contents each of which are incorporated by reference herein.

### FIELD OF THE DISCLOSURE

The disclosure relates to vehicles that can function within more than one legal classification category. The vehicles can be cycles capable of legally traveling on sidewalks and/or within bike lanes in certain modes and also capable of legally traveling in street traffic as a motor-vehicle in, for example, a moped or motorcycle mode.

### SUMMARY OF THE DISCLOSURE

A number of benefits are achieved by having a vehicle capable of operating in more than one legal classification category. As one example, a number of benefits could be achieved by having a vehicle capable of legally traveling on sidewalks and/or bike lanes and on city streets and highways.

In one example of such a vehicle, a rider could choose to start a trip on a street as a motor vehicle (including, without limitation, as a moped, or motorcycle). If traffic became congested, the rider could change the mode of the vehicle to a sidewalk and/or bike lane legal vehicle to avoid the traffic congestion.

In another example, a rider could choose to start a trip on a motor-equipped pedal-powered (MEPP) vehicle by pedaling the vehicle on a sidewalk or bike lane. During the trip the rider could find changing the cycle to a motor vehicle desirable. This change could be desirable due to time constraints, fatigue, amusement, or various other potential reasons.

In another example, a rider could pedal a MEPP vehicle while riding on a flat surface but change the mode to a motor vehicle for uphill portions of the travelled route. In another example, a rider may want to partake in a MEPP bicycle ride on a bike path. The entry point to the bike path may be a distance from the rider's origination point. The rider could begin the trip as a motor vehicle, traveling within street traffic. At the entry to the bike path, the rider could change the mode of the vehicle to a bike lane legal mode. In this example, the rider could ride on the bike trail for as long as desired. The rider could pedal all the way to a final destination or exit the bike path and change into a motor vehicle mode.

As can be appreciated from the foregoing examples, although pedal-only vehicles have a mobility advantage over motor vehicles, such as mopeds and motorcycles, motor vehicles have greater range and speed and the ability to travel within street traffic at appropriate speeds. By allowing the rider to choose which attributes are most convenient or desirable for a given situation, the rider receives the privileges and exercise potential of a pedal-powered cycle along with the benefits of a motor vehicle when desired.

### BRIEF DESCRIPTION OF THE DRAWINGS

FIG. 1. The arrows in FIG. 1 show convenient locations for the placement of a motor or motors on exemplary vehicles disclosed herein. While the arrows point to particular convenient locations of the vehicles disclosed herein, one of ordinary skill in the art will understand that motors can be mounted to, without limitation, any portion of any tube of a vehicle frame including any horizontal or diagonal tubes or any fork.

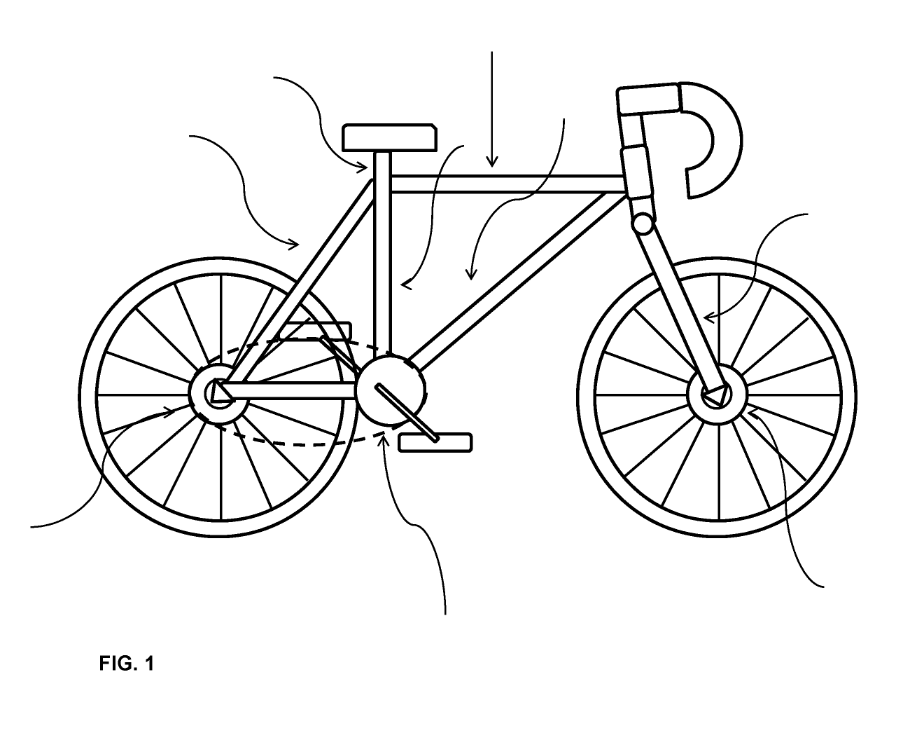

FIG. 2 The arrows in FIG. 2 show convenient locations for the placement of a battery or batteries on exemplary vehicles disclosed herein. While the arrows point to particular convenient locations of the vehicles disclosed herein, one of ordinary skill in the art will understand that batteries can be mounted to, without limitation, any portion of any tube of a vehicle frame including any horizontal or diagonal tubes or any fork.

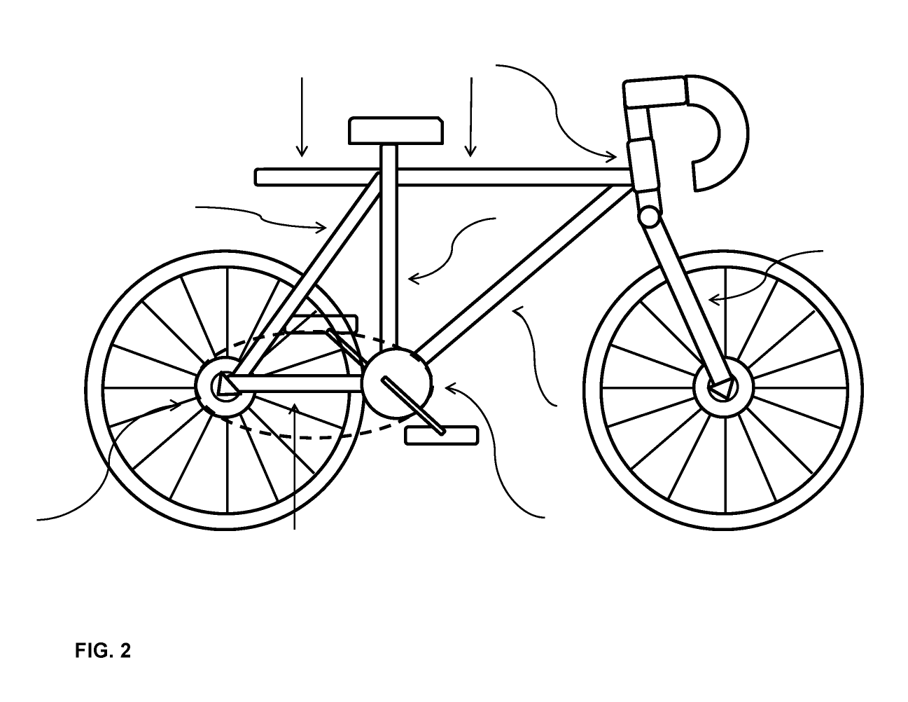

FIG. 3 depicts the embodiment described in Example 1.

### DETAILED DESCRIPTION

Disclosed herein are multi-modal vehicles that can function within more than one legal classification category. The vehicles can be motor-equipped pedal-powered (MEPP) vehicles capable of legally traveling on sidewalks and/or within bike lanes in certain modes and also capable of legally traveling in street traffic as motor vehicles (including, without limitation, mopeds or motorcycles) in different modes. This multi-modality is accomplished by allowing the rider to select between different available modes. When in “bike” mode, the vehicle will meet the legal requirements to allow the rider to utilize sidewalks and/or bike lanes. When in “street” or “motor vehicle” mode, the rider will be able to legally and safely operate the vehicle on the roadway among other motor vehicles at a safe and current traffic-appropriate speed.

As a general matter, MEPP vehicles are those that are capable of self-propulsion with a motor assist available. A common example of an MEPP vehicle is an electric bicycle (a bicycle with pedals and an electric motor for available assist). Under current exemplary regulations, to maintain the ability to travel on sidewalks and/or bike lanes, the motor cannot propel the vehicle faster than a set speed when the rider is not engaged in self propulsion. This maximum speed can be, for example, 20 miles per hour.

In one embodiment, when traveling on the sidewalk or in a bike lane, power to or of an MEPP vehicle's motor is restricted so that the vehicle will not exceed applicable legal requirements. In another embodiment, when traveling on the street or highway in motor vehicle mode, power to or of the MEPP vehicle's motor is augmented. In additional embodiments, different motors can power the MEPP vehicle depending on the mode that is engaged. The motors can have different power capacities depending on the current legal requirements defining modes of travel.

Beyond speed and/or power, other regulations can affect whether an MEPP vehicle is “sidewalk” legal, “bike lane” legal and/or “street” legal. In particular embodiments, beyond speed and/or power, the vehicles disclosed herein will include all features required to classify as a desired mode. For example, a motor vehicle can require a license plate while a cycle (for example, a unicycle or a bicycle) does not. To ensure that the MEPP vehicle can legally operate in all three modes, a license plate can be included. When operating in cycle mode, however, the license plate could retract, be obscured, become hidden, or be removed. The ability to retract, obscure or hide a feature such as a license plate could avoid confusion surrounding the vehicle's presence on a sidewalk or bike path when operating in a mode other than motor vehicle. Some motor vehicles additionally require rearview mirrors whereas cycles do not. Here again, the vehicles disclosed herein can include all features required to comply with the most restrictive legal classification mode. These features may optionally be retracted, obscured, hidden or otherwise removed when not required in a legal mode that does not require their presence. In particular embodiments, the vehicle can detect when required motor vehicle equipment is not present or functionally engaged and prevent the vehicle from entering a motor vehicle mode.

As used herein, the descriptor “pedal-powered” includes any vehicle that is solely human-powered through self-propulsion. The term “pedal” is not restrictive of the source of self-propulsion, although pedals reflect a common mechanism of such propulsion.

As used herein, the descriptor “motor-equipped pedal-powered” includes any vehicle that can be powered exclusively through human-powered self-propulsion but also has a motor to assist with propulsion when desired by the rider.

As used herein, the term “e-cycle” includes any cycle, regardless of the number of wheels, with fully operative pedals and at least one integrated electric motor that can be used for propulsion, capable of speeds not exceeding a current legal requirement to qualify for sidewalk and/or bike lane legality without rider pedaling (in one example an e-cycle cannot travel faster than 20 miles per hour without rider pedaling. In another example, an e-cycle can be a two- or three-wheeled vehicle with fully operable pedals and an electric motor of less than 750 watts (1 h.p.), whose maximum speed on a paved level surface, when powered solely by such a motor while ridden by an operator who weighs 170 pounds, is less than 20 mph).

As used herein, the term “moped” includes any vehicle, including a scooter, regardless of the number of wheels, with at least one integrated motor capable of propelling the vehicle at speeds greater than that of a legal requirement setting a limit for sidewalk and/or bike lane legality but less than that of a legal requirement setting the limit for motorcycle qualification. In one exemplary embodiment, the motor is capable of propelling vehicle greater than 20 miles per hour without human self-propulsion, but not exceeding 31 miles per hour without human propulsion.

As used herein, the term “motorcycle” includes any vehicle, regardless of the number of wheels, with at least one integrated motor capable of propelling the vehicle at a speed without human self propulsion that exceeds the legal limit for a moped. In one exemplary embodiment, this limit is greater than 31 miles per hour without human self propulsion.

As used herein, the term “motor vehicle equipment” can include, without limitation, a head lamp, a tail lamp, a stop lamp, reflectors, brakes, mirrors, a horn or warning device, turn signals, fenders, and/or a windshield as required by law, regulation, or ordinance in a particular jurisdiction. When motor vehicle equipment is deployed or removed based on a mode change, the deployment or removal can occur automatically or be performed manually by a rider or user.

As used herein, the term “pedal-powered motors” includes motors that can engage when a rider is engaged in self propulsion and preferably on the rider's command.

As used herein, the term “on-demand motors” includes motors that are engaged and operated manually using a throttle and regardless of whether a rider is engaged in self-propulsion.

As used herein, the term “geared motors” refers to motors that utilize internal gears.

As used herein, the term “direct-drive motors” refers to motors that utilize magnets to drive the wheel directly.

As used herein, a “motor vehicle” legal classification category includes an ability to operate a vehicle within the regulations required for motor vehicles, such as mopeds or motorcycles within general street traffic patterns that exclude the vehicle from qualifying for sidewalk and/or bike lane classification categories.

The vehicles disclosed herein use at least one battery to power at least one motor, which is controlled by at least one motor controller. The mode of the vehicle is chosen by a user (usually but not necessarily a rider) by input to at least one mode-selection device. The power and speed of the motor can be determined by how the motor controller delivers electricity to the motor.

Disclosed herein is also a kit that contains at least one battery to power at least one motor, which is controlled by at least one motor controller, and at least one mode-selection device. The contents of a kit allow a user to convert a standard pedal-powered vehicle to a multi-modal vehicle as disclosed herein.

Battery Component

Any combination of one or more batteries that provides sufficient voltage, wattage, and amperage is included within the scope of the present disclosure. Examples of batteries that could be used include, but are not limited to, standard batteries and rechargeable batteries. Examples of rechargeable batteries include those that can be recharged by plugging into a standard electrical outlet, those that can be recharged using the infrastructure in place for charging electric cars, those that can be recharged using recaptured energy from braking, those that can be recharged using solar energy, and those that can be recharged using any other type of renewable energy.

In one embodiment, a single 36-volt battery is used. In another embodiment, a single 72-volt battery is used. In another embodiment, two 18-volt batteries are used. In another embodiment, two 36-volt batteries are used. In another embodiment, a single 600-volt battery is used.

In one embodiment, the battery is capable of supplying power in multiple voltages. In another embodiment, the battery is capable of supplying power in a single voltage. In another embodiment, the battery will supply a single voltage and the motor controller will act to limit the revolutions per minute (RPMs) to predetermined levels corresponding to the mode the vehicle is in.

When motor-powered, the vehicles disclosed herein can run at least two different wattages. As will be understood by one of ordinary skill in the art, different wattages can be accomplished at a range of different voltages. The multiple voltages can allow the motors disclosed herein to run at different top speeds. In additional embodiments, a single (relatively high) voltage can be used and RPMs can be limited, when necessary or desirable based on mode-selection, using control software. In one particular embodiment, the wattage could exceed 250 in MEPP or e-cycle mode. In another embodiment, the wattage could exceed 275 watts in MEPP or e-cycle mode. In another embodiment, the wattage could exceed 300 watts in MEPP or e-cycle mode. In another embodiment, the wattage could exceed 325 watts in MEPP or e-cycle mode. In another embodiment, the wattage could exceed 350 watts in MEPP or e-cycle mode. In another embodiment, the wattage could exceed 375 watts in MEPP or e-cycle mode. In another embodiment, the wattage could exceed 400 watts in MEPP or e-cycle mode. In another embodiment, the wattage could exceed 425 watts in MEPP or e-cycle mode. In another embodiment, the wattage could exceed 450 watts in MEPP or e-cycle mode. In another embodiment, the wattage could exceed 475 watts in MEPP or e-cycle mode. In another embodiment, the wattage could exceed 500 watts in MEPP or e-cycle mode. In another embodiment, the wattage could exceed 525 watts in MEPP or e-cycle mode. In another embodiment, the wattage could exceed 550 watts in MEPP or e-cycle mode. In another embodiment, the wattage could exceed 575 watts in MEPP or e-cycle mode. In another embodiment, the wattage could exceed 600 watts in MEPP or e-cycle mode. In another embodiment, the wattage could exceed 625 watts in MEPP or e-cycle mode. In another embodiment, the wattage could exceed 650 watts in MEPP or e-cycle mode. In another embodiment, the wattage could exceed 675 watts in MEPP or e-cycle mode. In another embodiment, the wattage could exceed 700 watts in MEPP or e-cycle mode. In another embodiment, the wattage could exceed 800 watts in MEPP or e-cycle mode. In another embodiment, the wattage could exceed 900 watts in MEPP or e-cycle mode. In another embodiment, the wattage could exceed 1,000 watts in MEPP or e-cycle mode. In another embodiment, the wattage could exceed 1,100 watts in MEPP or e-cycle mode. In another embodiment, the wattage could exceed 1,200 watts in MEPP or e-cycle mode.

In one particular embodiment, the vehicle runs between 150 watts and 1,200 watts in MEPP or e-cycle mode. In another embodiment, the vehicle runs between 150 watts and 500 watts in MEPP or e-cycle mode. In another embodiment, the vehicle runs between 500 watts and 800 watts in MEPP or e-cycle mode. In another embodiment, the vehicle runs between 800 watts and 1,200 watts in MEPP or e-cycle mode. In another embodiment, the vehicle runs between 250 watts and 1,200 watts in MEPP or e-cycle mode. In another embodiment, the vehicle runs between 250 watts and 500 watts in MEPP or e-cycle mode. In another embodiment, the vehicle runs between 300 watts and 800 watts in MEPP or e-cycle mode. In another embodiment, the vehicle runs between 300 watts and 1,200 watts in MEPP or e-cycle mode.

In another embodiment, the vehicle runs between 150 watts and 400 watts in MEPP or e-cycle mode. In another embodiment, the vehicle runs between 250 watts and 500 watts in MEPP or e-cycle mode. In another embodiment, the vehicle runs between 350 watts and 600 watts in MEPP or e-cycle mode. In another embodiment, the vehicle runs between 300 watts and 650 watts in MEPP or e-cycle mode. In another embodiment, the vehicle runs between 400 watts and 750 watts in MEPP or e-cycle mode. In another embodiment, the vehicle runs between 500 watts and 750 watts in MEPP or e-cycle mode. In another embodiment, the vehicle runs between 600 watts and 950 watts in MEPP or e-cycle mode. In another embodiment, the vehicle runs between 700 watts and 950 watts in MEPP or e-cycle mode. In another embodiment, the vehicle runs between 800 watts and 1,050 watts in MEPP or e-cycle mode. In another embodiment, the vehicle runs between 900 watts and 1,150 watts in MEPP or e-cycle mode. In another embodiment, the vehicle runs between 700 watts and 1,250 watts in MEPP or e-cycle mode.

In one particular embodiment, the wattage could exceed 10,000 watts in moped or motorcycle mode. In one particular embodiment, the wattage could exceed 12,000 watts in moped or motorcycle mode. In another embodiment, the wattage could exceed 12,500 watts in moped or motorcycle mode. In another embodiment, the wattage could exceed 13,000 watts in moped or motorcycle mode. In another embodiment, the wattage could exceed 13,500 watts in moped or motorcycle mode. In another embodiment, the wattage could exceed 14,000 watts in moped or motorcycle mode. In another embodiment, the wattage could exceed 15,000 watts in moped or motorcycle mode. In another embodiment, the wattage could exceed 16,000 watts in moped or motorcycle mode. In another embodiment, the wattage could exceed 17,500 watts in moped or motorcycle mode. In another embodiment, the wattage could exceed 18,000 watts in moped or motorcycle mode. In another embodiment, the wattage could exceed 19,000 watts in moped or motorcycle mode. In another embodiment, the wattage could exceed 20,000 watts in moped or motorcycle mode. In another embodiment, the wattage could exceed 21,000 watts in moped or motorcycle mode. In another embodiment, the wattage could exceed 22,000 watts in moped or motorcycle mode. In another embodiment, the wattage could exceed 23,000 watts in moped or motorcycle mode. In another embodiment, the wattage could exceed 24,000 watts in moped or motorcycle mode. In another embodiment, the wattage could exceed 25,000 watts in moped or motorcycle mode. In another embodiment, the wattage could exceed 26,000 watts in moped or motorcycle mode. In another embodiment, the wattage could exceed 27,000 watts in moped or motorcycle mode. In another embodiment, the wattage could exceed 28,000 watts in moped or motorcycle mode. In another embodiment, the wattage could exceed 29,000 watts in moped or motorcycle mode. In another embodiment, the wattage could exceed 30,000 watts in moped or motorcycle mode. In another embodiment, the wattage could exceed 31,000 watts in moped or motorcycle mode. In another embodiment, the wattage could exceed 32,000 watts in moped or motorcycle mode. In another embodiment, the wattage could exceed 33,000 watts in moped or motorcycle mode. In another embodiment, the wattage could exceed 34,000 watts in moped or motorcycle mode. In another embodiment, the wattage could exceed 35,000 watts in moped or motorcycle mode. In another embodiment, the wattage could exceed 36,000 watts in moped or motorcycle mode. In another embodiment, the wattage could exceed 37,000 watts in moped or motorcycle mode. In another embodiment, the wattage could exceed 38,000 watts in moped or motorcycle mode. In another embodiment, the wattage could exceed 39,000 watts in moped or motorcycle mode. In another embodiment, the wattage could exceed 40,000 watts in moped or motorcycle mode. In another embodiment, the wattage could exceed 41,000 watts in moped or motorcycle mode. In another embodiment, the wattage could exceed 42,000 watts in moped or motorcycle mode. In another embodiment, the wattage could exceed 43,000 watts in moped or motorcycle mode. In another embodiment, the wattage could exceed 45,000 watts in moped or motorcycle mode. In another embodiment, the wattage could exceed 50,000 watts in moped or motorcycle mode. In another embodiment, the wattage could exceed 60,000 watts in moped or motorcycle mode. In another embodiment, the wattage could exceed 70,000 watts in moped or motorcycle mode. In another embodiment, the wattage could exceed 80,000 watts in moped or motorcycle mode.

In one particular embodiment, the wattage could run between 10,000 watts and 80,000 watts in moped or motorcycle mode. In another embodiment, the wattage could run between 13,000 watts and 80,000 watts in moped or motorcycle mode. In another embodiment, the wattage could run between 20,000 watts and 80,000 watts in moped or motorcycle mode. In another embodiment, the wattage could run between 30,000 watts and 80,000 watts in moped or motorcycle mode. In another embodiment, the wattage could run between 40,000 watts and 80,000 watts in moped or motorcycle mode. In another embodiment, the wattage could run between 50,000 watts and 80,000 watts in moped or motorcycle mode. In another embodiment, the wattage could run between 60,000 watts and 80,000 watts in moped or motorcycle mode. In another embodiment, the wattage could run between 70,000 watts and 80,000 watts in moped or motorcycle mode. In another embodiment, the wattage could run between 13,000 watts and 30,000 watts in moped or motorcycle mode. In another embodiment, the wattage could run between 13,000 watts and 40,000 watts in moped or motorcycle mode. In another embodiment, the wattage could run between 13,000 watts and 50,000 watts in moped or motorcycle mode. In another embodiment, the wattage could run between 13,000 watts and 60,000 watts in moped or motorcycle mode. In another embodiment, the wattage could run between 13,000 watts and 70,000 watts in moped or motorcycle mode.

In another embodiment, the wattage could run between 20,000 watts and 40,000 watts in moped or motorcycle mode. In another embodiment, the wattage could run between 20,000 watts and 50,000 watts in moped or motorcycle mode. In another embodiment, the wattage could run between 20,000 watts and 60,000 watts in moped or motorcycle mode. In another embodiment, the wattage could run between 20,000 watts and 70,000 watts in moped or motorcycle mode. In another embodiment, the wattage could run between 30,000 watts and 50,000 watts in moped or motorcycle mode. In another embodiment, the wattage could run between 30,000 watts and 40,000 watts in moped or motorcycle mode. In another embodiment, the wattage could run between 30,000 watts and 50,000 watts in moped or motorcycle mode. In another embodiment, the wattage could run between 30,000 watts and 60,000 watts in moped or motorcycle mode. In another embodiment, the wattage could run between 30,000 watts and 70,000 watts in moped or motorcycle mode. In another embodiment, the wattage could run between 40,000 watts and 50,000 watts in moped or motorcycle mode. In another embodiment, the wattage could run between 40,000 watts and 60,000 watts in moped or motorcycle mode. In another embodiment, the wattage could run between 40,000 watts and 70,000 watts in moped or motorcycle mode.

The battery can be carried by the rider or can be mounted to a portion of the vehicle. In certain embodiments, the battery is mounted to the frame of the vehicle.

Motor Component

Any combination of one or more motors that provides power ranges that meet current legal requirements of the disclosed modes are within the scope of this disclosure. In one embodiment, a motor can be attached to or installed in or near the rear hub of a bicycle, tricycle or quadricycle. In another embodiment, a motor can be attached to or installed in or near the front hub of a bicycle, tricycle or quadricycle. When applied to a unicycle, a motor can be attached to or installed in or near the hub of the one wheel. In another embodiment, a motor can be attached to the frame of a cycle, referred to herein as a “mid-drive” motor. In each of these embodiments, the motor can be an electric motor. The motor could also be powered by a gas such as, without limitation, a petroleum or natural gas product, subject to regulations in effect at the time.

Any combination of motors utilizing brushes and/or motors that are brushless can be used. Any combination of geared and/or direct-drive motors can be used. Any combination of pedal-powered motors and on-demand motors can be used. In one embodiment, a throttle is included. In another embodiment, more than one throttle is included.

Motor Controller Component

The vehicles disclosed herein include motor controller components that set the available power and/or speed that can be accessed by the vehicle when in a particular mode. Motor controller components can allow a vehicle to change modes by allowing access to increased power and/or speed; by reducing access to power and/or speed; by changing the motor that provides power and/or speed to propel the device.

Motor controllers can also include any additional safety precaution to prevent or reduce the likelihood of damage to the motor, motor controller, battery, rider and/or bystanders. In one embodiment the motor controller monitors the battery voltage and shuts down the motor if the battery voltage falls below a predetermined threshold. For example, a user could set the predetermined voltage threshold to be at a level that would prevent a rider from using the motorcycle mode if the amount of power in the battery drops below a level that would allow the rider to ride the vehicle as an e-cycle for 30 minutes. In another embodiment, the motor controller monitors the temperature of one or more key system components and shuts down the motor or lowers power output if the temperature exceeds a predetermined level. In another embodiment, the motor controller monitors the current provided to the motor and shuts down the system if it exceeds a predetermined level. In another embodiment, the motor controller monitors the current available to the motor and reduces the current to the motor if it exceeds a predetermined level. In another embodiment the motor controller shuts down the motor if the brake is applied at all, for a given duration, and/or at a given intensity.

Mode Change Mechanism

Any mode change mechanism that allows a user to select between a number of available modes could be used. The mode change mechanism could be chosen from the group including, but not limited to: a switch, a push button switch, a rocker switch, a touch switch, a rotary coded switch, a rotary switch; a key pad; a membrane keypad; a toggle; a slide control; a software based control; a key; a knob; a sensor that detects the presence of a license plate or other motor vehicle equipment; and a lever. Software based mode change mechanisms could be chosen from, without limitation, an application on a personal computer, a phone, such as, without limitation, a cell phone, a smart phone, an iPhone, an Android smart phone, a Windows Mobile smart phone; a Blackberry smart phone, etc. or an application on a device such as, without limitation, an iPod, a digital assistant, a bike computer, an on-board cycle computer, a handle-bar mounted computer, or an application on a tablet, such as, without limitation an iPad a Surface or an ASUS Transformer.

Integrated Systems

In the multi-modal vehicles disclosed herein, there can be any number of batteries powering any number of motor controllers controlling any number of motors. In one embodiment, the motor controller is capable of reducing the watt output of the battery to multiple levels. In another embodiment, there is one motor controller per motor. In another embodiment, there are two motor controllers per motor. In another embodiment, there is one motor controller and two motors. In another embodiment, there are three motor controllers per motor. In another embodiment, there is one motor controller and three motors. In another embodiment, there are two motor controllers and three motors.

Additional Modes/Control Options

Additional modes could also be created by the user either through hardware or software that could limit the speed, wattage, or rpms, or any combination thereof. For example, a user that has children could utilize a key to prevent another user, such as their child, from operating the cycle in any mode but e-cycle or pedal-powered mode.

In another embodiment, a user could have a software application on their smart phone that acts as a mode change mechanism, as well as a hardware mode change mechanism on the cycle itself. The user could then choose to prevent a second user from entering motorcycle mode by indicating this choice on their smart phone. The second user would then be able to choose from the allowed modes using the hardware mode change mechanism.

Motor Vehicle Equipment

In one embodiment, the vehicle is equipped with all legally required motor vehicle equipment. In another embodiment, the vehicle is equipped with all legally required motor vehicle equipment except for a license plate. In another embodiment, the vehicle is equipped with a license plate mount that automatically deploys when the multi-modal vehicle enters a motor vehicle mode. In another embodiment, the vehicle is equipped with a license plate mount that obscures the license plate automatically when the multi-modal vehicle is not in a motor vehicle mode. In another embodiment, the vehicle is equipped with a license plate mount wherein the license plate is removable and there is a sensor to detect the license plate's presence.

In another embodiment, the vehicle is equipped with a cycling computer. In another embodiment, the vehicle is equipped with a cycle speedometer. In another embodiment, the vehicle is equipped with a speedometer. In another embodiment, the vehicle is equipped with a dock for a smartphone wherein the smartphone is used as a speedometer. In another embodiment, the vehicle comes with the forms to register the converted multi-modal vehicle as required by the local jurisdiction.

In one embodiment, the vehicle is equipped with mirrors that automatically deploy when the multi-modal vehicle enters a motor vehicle mode. In another embodiment, the vehicle is equipped with mirrors wherein the mirrors are removable and there is a sensor to detect the mirror's presence. In another embodiment, the vehicle is equipped with mirrors that are obscured or hidden when the multi-modal vehicle enters into any non-motor vehicle mode. In another embodiment, the vehicle is equipped with mirrors that remain usable regardless of the mode chosen.

In one embodiment, the vehicle is equipped with a flashing bicycle light that automatically becomes a headlamp when the multi-modal vehicle enters into motor vehicle mode. In another embodiment, the vehicle is equipped with a headlamp that automatically deploys when the multi-modal vehicle enters into motor vehicle mode. In another embodiment, the vehicle is equipped with a headlamp wherein the headlamp is removable and there is a sensor to detect the headlamp's presence. In another embodiment, the vehicle is equipped with a headlamp that is obscured or hidden when the multi-modal vehicle enters into any non-motor vehicle mode. In another embodiment, the vehicle is equipped with a headlamp that is manually controlled by the user. In another embodiment, the vehicle is equipped with a headlamp that remains on regardless of the mode chosen.

In another embodiment, the vehicle is equipped with turn signals that automatically deploy or activate when the multi-modal vehicle enters motor vehicle mode. In another embodiment, the vehicle is equipped with turn signals that are integrated into the mirrors. In another embodiment, the vehicle is equipped with turn signals wherein the turn signals are removable and there is a sensor to detect the turn signals' presence. In another embodiment, the vehicle is equipped with turn signals that are obscured or hidden when the multi-modal vehicle enters into any non-motor vehicle mode. In another embodiment, the vehicle is equipped with turn signals that remain usable regardless of the mode chosen.

Kits to Retrofit Existing Cycles

Disclosed herein are also kits to retrofit existing cycles from and to a variety of different multi-modal vehicles disclosed herein. In one embodiment the kits contain at least one battery to power at least one motor, which is controlled by at least one motor controller, and at least one mode-selection device. The contents of particular kits allow a user to convert a standard pedal-powered vehicle or an e-cycle to a multi-modal vehicle as disclosed herein.

A kit can contain any combination of the components described herein. In one embodiment, a kit contains all components required to retrofit a pedal-cycle, including at least one battery to power at least one motor, which is controlled by at least one motor controller, at least one mode-selection device. In another embodiment, a kit contains all of the components required to convert an e-cycle to a multi-modal vehicle as disclosed herein including, for example at least one battery to power at least one motor, which is controlled by at least one motor controller, and at least one mode-selection device. In another embodiment, the kit includes all of the components of a multi-modal vehicle as disclosed herein including at least one battery to power at least one motor, which is controlled by at least one motor controller, at least one mode-selection device. In additional embodiments, the kits can include only motors and mode-selection devices with batteries sold separately.

In another embodiment, the kit includes a subset of the components required to convert an existing pedal-powered vehicle or e-cycle into a multi-modal vehicle, such as for example, a motor and a motor controller; a motor controller and a mode-selection device; a battery and a motor controller; or a motor and a battery. In another embodiment, the kit includes bolt-on mounts for any or all of the components. In another embodiment, the kit includes brakes.

In another embodiment, the kit includes all legally required motor vehicle equipment. In another embodiment, the kit includes all legally required motor vehicle equipment except for a license plate. In another embodiment, the kit includes a license plate mount that automatically deploys when the multi-modal vehicle enters a motor vehicle mode. In another embodiment, the kit includes a license plate mount that obscures the license plate automatically when the multi-modal vehicle is not in a motor vehicle mode. In another embodiment, the kit includes a license plate mount wherein the license plate is removable and there is a sensor to detect the license plate's presence.

In another embodiment, the kit includes a cycling computer. In another embodiment, the kit includes a cycle speedometer. In another embodiment, the kit includes a speedometer. In another embodiment, the kit includes a dock for a smartphone wherein the smartphone is used as a speedometer.

In another embodiment, the kit includes the forms to register the converted multi-modal vehicle as required by the local jurisdiction. In another embodiment, the kit includes a voucher for the cost of taking a motorcycle safety training class. In another embodiment, the kit includes a coupon for a discounted price for a motor cycle training class.

In one embodiment, the kit includes mirrors that automatically deploy when the multi-modal vehicle enters a motor vehicle mode. In another embodiment, the kit includes mirrors wherein the mirrors are removable and there is a sensor to detect the mirror's presence. In another embodiment, the kit includes mirrors that are obscured or hidden when the multi-modal vehicle enters into any non-motor vehicle mode. In another embodiment, the kit includes mirrors that remain usable regardless of the mode chosen.

In one embodiment, the kit includes a flashing bicycle light that automatically becomes a headlamp when the multi-modal vehicle enters into motor vehicle mode. In another embodiment, the kit includes a headlamp that automatically deploys when the multi-modal vehicle enters into motor vehicle mode. In another embodiment, the kit includes a headlamp wherein the headlamp is removable and there is a sensor to detect the headlamp's presence. In another embodiment, the kit includes a headlamp that is obscured or hidden when the multi-modal vehicle enters into any non-motor vehicle mode. In another embodiment, the kit includes a headlamp that is manually controlled by the user. In another embodiment, the kit includes a headlamp that remains on regardless of the mode chosen.

In another embodiment, the kit includes turn signals that automatically deploy or activate when the multi-modal vehicle enters motor vehicle mode. In another embodiment, the kit includes turn signals that are integrated into the mirrors. In another embodiment, the kit includes turn signals wherein the turn signals are removable and there is a sensor to detect the turn signals' presence. In another embodiment, the kit includes turn signals that are obscured or hidden when the multi-modal vehicle enters into any non-motor vehicle mode. In another embodiment, the kit includes turn signals that remain usable regardless of the mode chosen.

In another embodiment, the kit includes all of the tools that would be necessary to retrofit an existing pedal-powered vehicle or e-cycle in order to convert it to a multi-modal vehicle as disclosed herein. Exemplary tools include, but are not limited to, allen wrenches of various sizes; wrenches of various sizes; ratchets; sockets of various sizes; screwdrivers, both phillips and flat-head; appropriate cutting tools; wire strippers; soldering irons; solder; shrink wrap; heat guns; drills; and angle grinder. In another embodiment, the kit includes instructions illustrating the process of retrofitting an existing pedal-powered vehicle or e-cycle in order to convert it to a multi-modal vehicle as disclosed herein. In another embodiment, the kit includes a disc with instructional videos detailing the process of converting an existing pedal-powered vehicle or e-cycle to a multi-modal vehicle as disclosed herein.

In one embodiment, the kit includes a helmet with the safety rating required by local laws, regulations, or ordinances for use on a motorcycle. In another embodiment, the kit includes additional padding such as elbow pads, knee pads, or a back protector. In another embodiment, the kit includes additional reflectors or lights to attach to the vehicle in order to increase visibility. In another embodiment, the kit includes a jacket or other garment made of abrasion-resistant material. In another embodiment, the kit includes a jacket or other garment with armoring. In another embodiment, the kit includes a windshield that can be installed onto the multi-modal vehicle.

In another embodiment, the kit includes protective boots. In another embodiment, the kit includes protective boots that are compatible with clip-in pedals. In another embodiment, the kit includes protective boots that are compatible with clipless pedals. In another embodiment, the kit includes a rear seat that can be mounted to allow a passenger to be transported.

In another embodiment, the kit includes a personal kinetic energy generator. In another embodiment, the kit includes a portable solar generator. In another embodiment, the kit includes a portable battery back up.

In another embodiment, the kit includes an alarm that can be installed on the multi-modal vehicle. In another embodiment, the kit includes a security lock that can be used with the multi-modal vehicle.

In another embodiment, the kit includes finishing components, which can include, but are not limited to, paint; molded dressings; larger tires; decals; and/or fairings. In another embodiment, the kit includes relays that automatically turn off ground effect lighting when the vehicle enters a motor vehicle mode.

### EXAMPLES

The Examples below are included to demonstrate particular embodiments of the disclosure. Those of ordinary skill in the art will recognize in light of the present disclosure that many changes can be made to the specific embodiments disclosed herein and still obtain a like or similar result without departing from the spirit and scope of the disclosure.

### Example 1

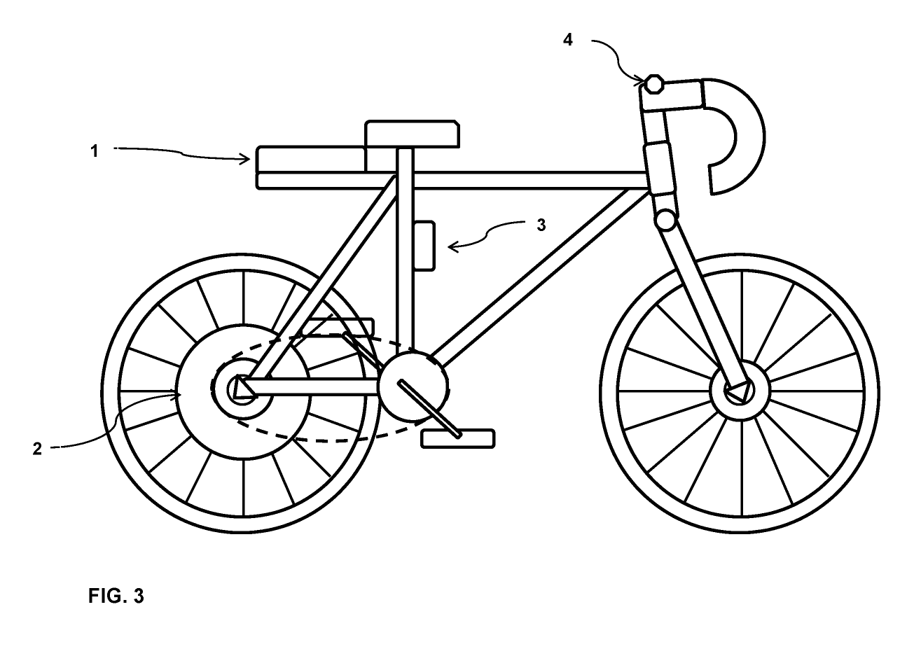

A bicycle outfitted with motor vehicle equipment is equipped with a 72-volt battery 1, a rear-hub motor 2, and a motor controller 3 (FIG. 3). The mode change mechanism 4 is a toggle connected to the motor controller and mounted on the handlebars. When the toggle is in an e-cycle position, the motor controller limits the wattage from the battery that is input to the motor to a predetermined threshold. In this mode, the cycle meets all the legal requirements of an e-cycle. When the toggle is moved into a second (moped) position, the motor controller allows the wattage that reaches to the motor to increase. In particular embodiments, motor vehicle equipment required for a moped is also automatically or manually deployed. The cycle then meets all of the legal requirements of a moped. When the toggle is moved into a third (motorcycle) position, the wattage input to the motor is further increased. In particular embodiments, motor vehicle equipment required for a motorcycle is also automatically or manually deployed. The cycle then meets all of the legal requirements of a motorcycle.

### Example 2

A cycle is equipped with two 36-volt batteries, a mid-drive motor, and a single motor controller. The mode change mechanism is a key that can be turned to select e-cycle mode or motorcycle mode. When the key is turned to e-cycle mode, the motor controller draws power from the two batteries in parallel. While in this mode the motor controller provides power levels that meet the legal requirements of an e-cycle. When the key is turned to motorcycle mode, the motor controller draws power from the two batteries in series, effectively doubling the output voltage. In particular embodiments, when the key is turned to motorcycle mode, required motor vehicle equipment is also automatically or manually deployed. While the batteries are powering the motor in series, the cycle meets all of the legal requirements of a motorcycle.

### Example 3

A cycle is outfitted with one 72-volt battery, a rear hub motor, a front hub motor, and two motor controllers. The mode change mechanism is an application on the user's smart phone, which is in a dock attached to the handlebars of the cycle. When in pedal-powered mode, neither motor is active, and the cycle meets all legal requirements of a pedal-powered cycle. The user then changes the mode on their smart phone from pedal-powered mode to e-cycle mode (this change could also occur by simply turning the power on), and one of the motor controllers activates the rear hub motor. While in e-cycle mode, the cycle meets all of the legal requirements of an e-cycle. When the user wishes to change to motorcycle mode, they simply indicate this in the application on their smart phone and the second motor controller simultaneously activates the front hub motor. In particular embodiments, required motor vehicle equipment is then automatically or manually deployed. While in motorcycle mode, the cycle meets all of the legal requirements of a motorcycle.

### Example 4

A cycle is outfitted with two 36-volt batteries, a rear hub motor, a front hub motor, and two motor controllers. There are two mode control mechanisms, one is a mode lock application on a first user's smart phone, and the other is a mode change mechanism such as a key. The first user has the ability to use the key to switch into pedal-powered mode (no motors are active), e-cycle mode (one motor is active and the batteries are running in parallel), moped mode (one motor is active and the batteries are running in series), or motorcycle mode (both motors are active and the batteries are running in series). In each of these modes, the vehicle meets the appropriate legal requirements.

The first user may then loan their vehicle to a second user. If the first user does not wish the second user to be able to run the cycle in motorcycle mode, the first user can use the application on their smart phone to lock out this option from the second user. The second user may then choose from pedal-powered mode, e-cycle mode, or moped mode using the key, but if they attempt to switch into motorcycle mode, the second motor will not activate.

### Example 5

A cycle is outfitted with one 72-volt battery, a rear hub motor, a front hub motor, a mid-drive motor, and a single motor controller. Two switches are used as mode change mechanisms. When operating as an e-cycle, the rear hub motor is activated. In order to switch into moped mode, the first of the switches is flipped and the front hub motor is activated. When the user wishes to switch into motorcycle mode, the second of the switches is flipped and the mid-drive motor is activated. In each of these modes, the cycle meets the appropriate legal requirements.

### Example 6

A cycle is outfitted with one 72-volt battery, a mid-drive motor, and a single motor controller. A knob is used as a mode change mechanism. When operating as an e-cycle, the watt output of the battery can exceed 300 watts. In order to switch into motorcycle mode, the knob is turned and the watt output of the battery can exceed 13,000 watts. In each of these modes, the cycle meets the appropriate legal requirement.

### Exemplary Embodiments

1. A vehicle including a battery, a motor, a motor controller, and a mode change mechanism wherein the vehicle legally operates in at least two legal classification categories and wherein one legal classification category allows operation on a sidewalk and/or in a bike lane and the second legal classification category allows operation in a motor vehicle classification category.
2. A vehicle of embodiment 1 wherein the vehicle legally operates in at least three classification categories.
3. A vehicle of embodiment 1 or 2 wherein the classification categories are mutually exclusive.
4. A vehicle of embodiment 1, 2, or 3 wherein the vehicle is a cycle.
5. A vehicle of embodiment 1, 2, 3, or 4 wherein the vehicle is an electric cycle.
6. A vehicle according to embodiment 1, 2, 3, 4, or 5 wherein the vehicle is an electric bicycle.
7. A vehicle of embodiment 1, 2, 3, 4, 5, or 6 wherein the mode change mechanism changes a setting in the motor controller which varies the wattage input into the motor.
8. A vehicle of embodiment 1, 2, 3, 4, 5, 6, or 7 wherein there are two motors and the mode change mechanism is used to change between modes by causing the single motor controller to power one motor on or off.
9. A vehicle of embodiment 1, 2, 3, 4, 5, 6, or 7 wherein there are two motors, each with a separate motor controller, and the mode change mechanism is used to change between modes by causing the motor controllers to power their respective motor on or off.
10. A vehicle of embodiment 1, 2, 3, 4, 5, 6, or 7 wherein there are two batteries and the mode change mechanism is used to change between modes by causing the motor controller to change between running the two batteries in parallel or in series.
11. A vehicle of embodiment 1, 2, 3, 4, 5, 6, or 7 wherein there are two motor controllers, one for each output voltage, and the mode change mechanism is used to change between the modes of the vehicle by activating one motor controller and deactivating the other motor controller.
12. A vehicle of embodiment 1, 2, 3, 4, 5, 6, or 7 wherein there is a single motor controller.
13. A vehicle of embodiment 1, 2, 3, 4, 5, 6, or 7 wherein there are three motors, and the mode control mechanism acts to determine which combination of the three is active.
14. A vehicle of embodiment 1, 2, 3, 4, 5, 6, or 7 wherein gears of the vehicle can be shifted by a rider during use.
15. A vehicle of embodiment 1, 2, 3, 4, 5, 6, or 7 wherein gears of the vehicle are shifted automatically during use.
16. A vehicle of embodiment 1, 2, 3, 4, 5, 6, or 7 wherein a license plate is displayed when the vehicle is in a motor vehicle mode.
17. A vehicle of embodiment 1, 2, 3, 4, 5, 6, 7, 8, 9, 10, 11, 12, 13, 14, 15, or 16 further including a mode lock mechanism,
18. A kit including a battery, a motor, a motor controller, and at least one mode change mechanism wherein when installed the mode change mechanism allows the vehicle to legally operate within different legal classification categories.
19. The kit of embodiment 18 wherein mode change mechanism allows change between at least three legal classification categories.
20. The kit of embodiment 18 or 19 wherein the mode change mechanism is used to change the mode of the vehicle by changing a setting in the motor controller which varies the wattage input into the motor.
21. The kit of embodiment 18 or 19 wherein there are two motors and the mode change mechanism changes modes of the vehicle by causing the motor controller to power one motor on and off.
22. The kit of embodiment 18 or 19 wherein there are two motors, each with a separate motor controller, and the mode change mechanism changes modes of the vehicle by causing each of the motor controllers to power their respective motor on or off.
23. The kit of embodiment 18 or 19 wherein there are two batteries and the mode change mechanism changes modes of the vehicle by causing the motor controller to change between running the two batteries in parallel or in series,
24. The kit of embodiment 18 or 19 wherein there are two motor controllers, one for each output voltage, and the mode change mechanism changes the modes of the vehicle by activating one motor controller and deactivating the other motor controller.
25. The kit of embodiment 18 or 19 wherein there is a single motor controller.
26. The kit of embodiment 18 or 19 wherein there are three motors, and the mode change mechanism determines which combination of the three motors is active.
27. The kit of embodiment 18, 19, 20, 21, 22, 23, 24, 25, or 26 further including a mode lock mechanism.

As will be understood by one of ordinary skill in the art, each embodiment disclosed herein can comprise, consist essentially of, or consist of its particular stated element, step, ingredient or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless otherwise indicated, all numbers used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

Definitions and explanations used in the present disclosure are meant and intended to be controlling in any future construction unless clearly and unambiguously modified in the examples or when application of the meaning renders any construction meaningless or essentially meaningless. In cases where the construction of the term would render it meaningless or essentially meaningless, the definition should be taken from Webster's Dictionary, 3rd Edition or a dictionary known to those of ordinary skill in the art.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A vehicle comprising a battery, a motor, a motor controller, and a mode change mechanism wherein the vehicle legally operates in at least two legal classification categories and wherein one legal classification category allows operation on a sidewalk and/or in a bike lane and the second legal classification category allows operation in a motor vehicle classification category.

2. A vehicle of claim 1, wherein the vehicle legally operates in at least three classification categories.

3. A vehicle of claim 2, wherein the classification categories are mutually exclusive.

4. A vehicle of claim 1, wherein the vehicle is a cycle.

5. A vehicle of claim 4, wherein the vehicle is an electric cycle.

6. A vehicle according to claim 5, wherein the vehicle is an electric bicycle.

7. A vehicle of claim 1, wherein the mode change mechanism changes a setting in the motor controller which varies the wattage input into the motor.

8. A vehicle of claim 1, wherein there are two motors and the mode change mechanism is used to change between modes by causing the single motor controller to power one motor on or off.

9. A vehicle of claim 1, wherein there are two motors, each with a separate motor controller, and the mode change mechanism is used to change between modes by causing the motor controllers to power their respective motor on or off.

10. A vehicle of claim 1, wherein there are two batteries and the mode change mechanism is used to change between modes by causing the motor controller to change between running the two batteries in parallel or in series.

11. A vehicle of claim 1, wherein there are two motor controllers, one for each output voltage, and the mode change mechanism is used to change between the modes of the vehicle by activating one motor controller and deactivating the other motor controller.

12. A vehicle of claim 1, wherein there is a single motor controller.

13. A vehicle of claim 1, wherein there are three motors, and the mode control mechanism acts to determine which combination of the three is active.

14. A vehicle of claim 1, wherein gears of the vehicle can be shifted by a rider during use.

15. A vehicle of claim 1, wherein gears of the vehicle are shifted automatically during use.

16. A vehicle of claim 1, wherein a license plate is displayed when the vehicle is in a motor vehicle mode.

17. A vehicle of claim 1, further comprising a mode lock mechanism.

18. A kit comprising a battery, a motor, a motor controller, and at least one mode change mechanism wherein when installed the mode change mechanism allows the vehicle to legally operate within different legal classification categories.

19. The kit of claim 18, wherein mode change mechanism allows change between at least three legal classification categories.

20. The kit of claim 18, wherein the mode change mechanism is used to change the mode of the vehicle by changing a setting in the motor controller which varies the wattage input into the motor.

21. The kit of claim 18, wherein there are two motors and the mode change mechanism changes modes of the vehicle by causing the motor controller to power one motor on and off.

22. The kit of claim 18, wherein there are two motors, each with a separate motor controller, and the mode change mechanism changes modes of the vehicle by causing each of the motor controllers to power their respective motor on or off.

23. The kit of claim 18, wherein there are two batteries and the mode change mechanism changes modes of the vehicle by causing the motor controller to change between running the two batteries in parallel or in series.

24. The kit of claim 18, wherein there are two motor controllers, one for each output voltage, and the mode change mechanism changes the modes of the vehicle by activating one motor controller and deactivating the other motor controller.

25. The kit of claim 18 wherein there is a single motor controller.

26. The kit of claim 18 wherein there are three motors, and the mode change mechanism determines which combination of the three motors is active.

27. The kit of claim 18 further comprising a mode lock mechanism.
